(19) United States
(12) Patent Application Publication
(10) Pub. No.: US 2017/0191371 A1
(43) Pub. Date: Jul. 6, 2017

(54) WHEEL DISC WITH AT LEAST ONE SEALING PLATE

(71) Applicant: Siemens Aktiengesellschaft, Munich (DE)

(72) Inventors: Sascha Dungs, Wesel (DE); Harald Hoell, Wächtersbach (DE); Kevin Kampka, Mülheim a. d. Ruhr (DE); Karsten Kolk, Mülheim a.d. Ruhr (DE); Marc Lange, Köln (DE); Peter Schröder, Essen (DE); Vyacheslav Veitsman, Gelsenkirchen (DE)

(73) Assignee: Siemens Aktiengesellschaft, Munich (DE)

(21) Appl. No.: 15/302,019

(22) PCT Filed: Mar. 31, 2015
(86) PCT No.: PCT/EP2015/056985

§ 371 Date: Oct. 5, 2016

(30) Foreign Application Priority Data
Apr. 15, 2014 (EP) 14164724.8

(51) Int. Cl. F01D 11/00; F01D 5/02

(52) U.S. Cl. CPC F01D 11/003; F01D 5/02; F05D 2220/32; F05D 2240/24; F05D 2260/30

(57) ABSTRACT

A wheel disc with at least one sealing metal sheet, which is fixed to the wheel disc in a movable manner in the circumferential direction of the wheel disc, and with at least one securing device, which is designed to secure the at least one sealing metal sheet against a displacement in the circumferential direction of the wheel disc in the correctly assembled state. The securing device has a screw, which is screwed to the sealing metal sheet and which extends through the sealing metal sheet, and a depression, which is provided on the wheel disc and which receives the free end of the screw in the correctly assembled state and the wall of which restricts a movement of the screw in the circumferential direction.

### CROSS REFERENCE TO RELATED APPLICATIONS

This application is the US National Stage of International Application No. PCT/EP2015/056985 filed Mar 31, 2015, and claims the benefit thereof. The International Application claims the benefit of European Application No. EP14164724 filed Apr. 15, 2014. All of the applications are incorporated by reference herein in their entirety.

### FIELD OF INVENTION

The present invention relates to a wheel disk with at least one sealing plate which is fastened to the wheel disk so that it can be displaced in the circumferential direction of the latter, and with at least one securing device which is designed such that it secures the at least one sealing plate in the properly mounted state against displacement in the circumferential direction of the wheel disk.

### BACKGROUND OF INVENTION

Wheel disks of this type are known in the prior art. They form components of rotors such as, for example, gas turbine rotors or the like. Normally, multiple sealing plates are arranged on a wheel disk so that they can be displaced in the circumferential direction of the latter. The sealing plates can thus be inserted, for example with their radially inward-facing edge, into a circumferential groove provided on the wheel disk. In order to ensure that the sealing plates function as intended, it is necessary to secure the individual sealing plates against displacement in the circumferential direction, for which purpose corresponding securing devices are used. The latter can, for example, be formed by a screw which extends through a through hole provided in the sealing plate, and a threaded bore provided on the wheel disk and into which the screw is screwed in the properly mounted state. However, a problem arises with a securing device designed in such a way, in that the notch effect associated with the threaded bore provided in the wheel disk can cause problems. Moreover, during servicing screws can often no longer be loosened, which entails costly drilling-out of the joint.

Other wheel disks with sealing plates arranged thereon are disclosed in JP-S-58 35203 A, U.S. Pat. No. 5,030,063, U.S. Pat. No. 5,263,823, U.S. Pat. No. 5,277,548, DE 19 28 184, EP-A-1 840 338, EP-A-2 518 271.

### SUMMARY OF INVENTION

Based on this prior art, an object of the present invention is to provide a wheel disk of the type mentioned at the beginning with an alternative securing device which only slightly affects the rigidity of the wheel disk and can be replaced easily during servicing.

In order to achieve this object, the present invention provides a wheel disk of the type mentioned at the beginning which is characterized in that the securing device has a screw, which is screwed to the sealing plate and extends through the latter, and an indentation, provided on the wheel disk, which receives the free end of the screw in the properly mounted state and the wall of which limits movement of the screw in the circumferential direction.

Owing to the fact that the screw is screwed according to the invention to the sealing plate and not to the wheel disk, the wheel disk, which is a much more expensive component than the sealing plate, is prevented from being affected by a notch effect caused by a thread. Moreover, a screw which is screwed to the sealing plate can be removed during servicing relatively simply without damaging the wheel disk, even when the screwed connection cannot be loosened.

The indentation is advantageously designed as a slot, extending transversely to the circumferential direction, in the wheel disk. Production-related tolerances, thermal expansion or the like can correspondingly be easily compensated.

According to the invention, the screw is screwed into a sleeve provided with an internal thread and which is held non-rotatably in a through hole provided on the sealing plate. Such a sleeve has the advantage that it can be replaced simply during servicing. Proper fastening of the screw can also be ensured by such a sleeve, even if the sealing plate has only a low thickness.

The sleeve advantageously has at least one radially outward protruding projection which, during the insertion of the sleeve into the through hole, is introduced into a corresponding recess which extends from the through hole. A structurally simple anti-rotation device, which can additionally be mounted easily, is obtained in this way.

The recess of the through hole is advantageously accessible from that side of the sealing plate which faces the indentation provided on the wheel disk in the properly mounted state. In other words, the sleeve is advantageously mounted from the rear of the sealing plate so that the sleeve is secured automatically on the sealing plate when the screw is screwed in.

A retaining means is advantageously provided which secures the screw on the sealing plate in the properly mounted state. In this way, the screw can be prevented from accidentally coming loose during the proper operation of the wheel disk.

According to an embodiment of the present invention, the retaining means has a securing ring which is provided with radially outward protruding securing projections which, in the properly mounted state, engage in receiving indentations formed correspondingly on the screw and on the sealing plate in such a way that rotation of both the screw and the securing ring is prevented. The receiving indentations can extend, for example, in each case in an axial direction in such a way that the securing projections can be bent into the receiving indentations after the screw is tightened.

The screw is advantageously designed so that it is rounded at its free end with which it engages in the indentation of the wheel disk in the properly mounted state. Any damage to the wheel disk by the screw can accordingly be prevented.

According to an embodiment of the present invention, the at least one sealing plate is held positively on the wheel disk. The at least one sealing plate can advantageously have an edge region which is designed in the manner of a bead and is received in a correspondingly designed undercut receiving groove of the wheel disk.

### BRIEF DESCRIPTION OF THE DRAWINGS

Other features and advantages of the present invention become clear with the aid of the following description of a wheel disk according to an embodiment of the present invention and with reference to the attached drawings, in which:

FIG. 1 is a perspective lateral cross-sectional view of a region of a wheel disk according to an embodiment of the present invention on which a sealing plate is held;

FIG. 2 shows a perspective front view of the wheel disk shown in FIG. 1;

FIG. 3 shows a perspective rear view of the sealing plate shown in FIG. 1;

FIG. 4 shows a perspective view of a sleeve shown in FIGS. 1 and 3;

FIG. 5 shows a perspective view of a retaining means shown in FIGS. 1 and 3;

FIG. 6 shows a perspective view of a screw shown in FIGS. 1 and 3;

FIG. 7 shows a perspective front view of the sealing plate shown in FIGS. 1 and 3;

FIG. 8 shows an enlarged view of the portion of the sealing plate labeled with the reference numeral VIII in FIG. 7; and

FIG. 9 shows a perspective rear view of the sealing plate portion shown in FIG. 8.

### DETAILED DESCRIPTION OF INVENTION

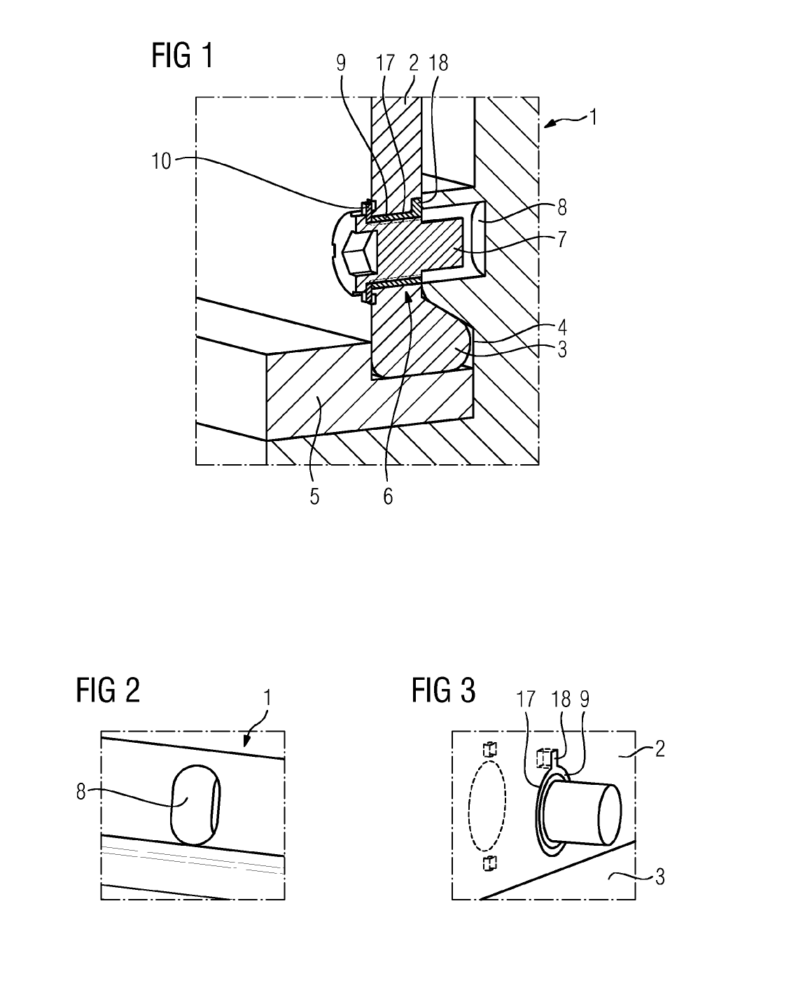

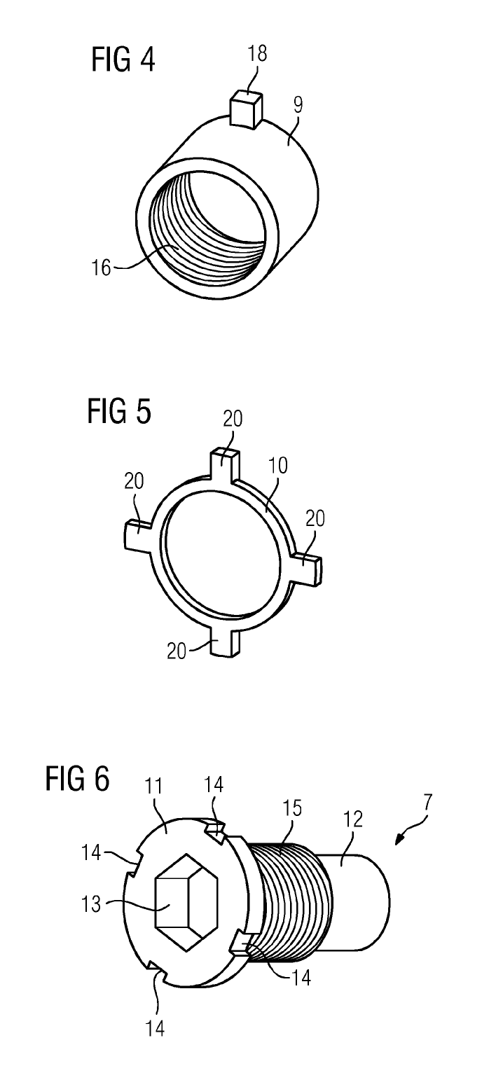

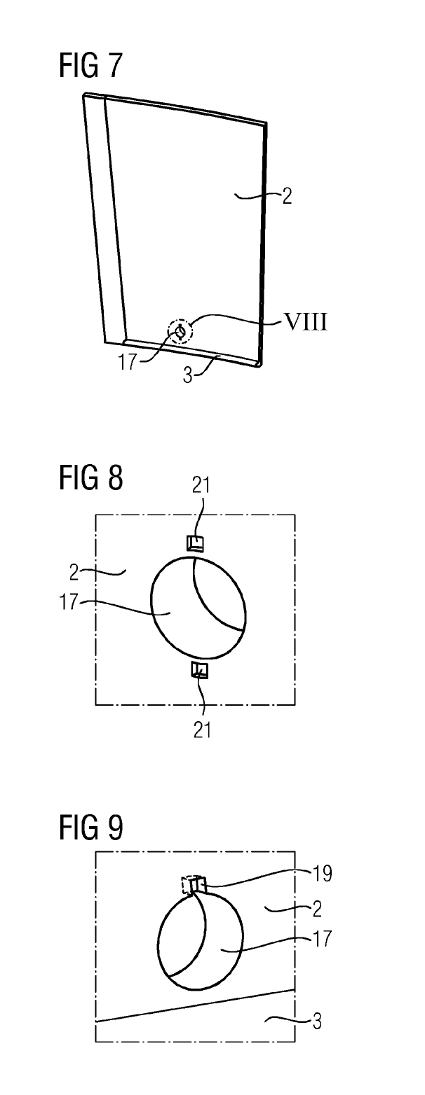

FIGS. 1 to 9 show a wheel disk 1 according to an embodiment of the present invention, or components of the same. The wheel disk 1 comprises multiple sealing plates 2 which are fastened to said wheel disk 1 so that they can be displaced in the circumferential direction. The radially inward-facing edge of the sealing plate 2 is for this purpose provided with a bead 3 which is received in an undercut receiving groove 4 so that it can be displaced in the circumferential direction, wherein the receiving groove 4 is formed by the wheel disk 1, on the one hand, and by a locking piece 5 which has an L-shaped cross section in the present case and is fastened to the wheel disk 1, on the other hand. At this point it should be pointed out that the bead 3 and the receiving groove 4 represent only one example of a positive connection, and that in principle other positive connections for fastening the sealing plate 2 to the wheel disk 1 can also be used. In order to prevent the sealing plates 2 from being able to be displaced in the circumferential direction in the properly mounted state, each sealing plate 2 is provided with at least one securing device 6 which has, as individual components, a screw 7, an indentation 8 provided on the wheel disk 1, a sleeve 9 and a securing ring 10.

The screw 7 comprises a screw head 11 and a screw shaft 12. An Allen key socket 13 is arranged in known fashion at the center of the screw head 11.

Four receiving indentations 14 are evenly distributed along the circumference of the screw head 11 and extend axially through the screw head 11. The screw shaft 12 is provided with an external thread 15 and designed so that it is rounded at its free end.

The indentation 8 of the wheel disk 1 serves to receive the screw 7, as explained in detail below, and has corresponding dimensions. It is designed as a slot extending transversely to the circumferential direction.

The sleeve 9 is provided with an internal thread 16 which matches the external thread 15 of the screw 7. The sleeve 9, which is inserted into a through hole 17 of the sealing plate 2 in the proper state, comprises at its rear free end a radially outward protruding projection 18 which, whilst the sleeve 9 is being pushed into the through opening 17, is introduced into a corresponding recess 19 which extends from the through hole 17 and can be accessed from that side of the sealing plate 2 which faces the indentation 8.

The securing ring 10 is provided with four radially outward protruding securing projections 20 evenly distributed along the circumference, the dimensions of which are selected in such a way that they can be received in the receiving indentations 14 of the screw 7, on the one hand, and in receiving indentations 21, on the other hand, which are arranged on the front side of the sealing plate 2 on mutually opposite sides of the through hole 17.

In order to mount the sealing plate 2 on the wheel disk 1, in a first step the bead 3 is arranged at the proper position on the wheel disk 1 in such a way that the through hole of the sealing plate 2 and the indentation 8 of the wheel disk are arranged flush with each other, whereupon the locking piece 5 is positioned and fastened on the wheel disk 1. The bead 3 is now received in the undercut receiving groove 4 so that it can be displaced in the circumferential direction.

In order to prevent displacement of the sealing plate 2 in the circumferential direction, the sleeve 9 is now pushed into the associated through hole 17 from the rear side of the sealing plate 2, and the projection 18 of the sleeve 9 is thus introduced into the recess 19 of the sealing plate 2 such that the sleeve 9 can no longer rotate within the through hole 17. In a further step, the securing ring 10 is pushed onto the screw shaft 12 of the screw 7, whereupon the latter is screwed into the sleeve 9 in such a way that the free end of the screw shaft 12 is received in the indentation 8 provided on the wheel disk 1. After the screw 7 has been tightened, mutually opposite securing projections 20 of the securing ring 10 are now bent forward into the receiving indentations 14 of the screw 7. The other two securing projections 20 of the securing ring 10 are bent backward into the associated receiving indentations 21 of the sealing plate 2. The screw 7 is now held captively on the sealing plate 2 and engages into the indentation 8 of the wheel disk 1. Movement of the screw 7 and hence of the sealing plate 2 in the circumferential direction is correspondingly limited or prevented by the corresponding walls of the indentation 8.

An essential advantage connected with the securing device 6 according to the invention consists in the wheel disk 1, which forms a comparatively expensive component, not being affected in any way by notch effects. The securing device 6 can moreover be loosened or replaced in a problem-free manner as part of maintenance work. Owing to the fact that the indentation 8 is designed as a slot, manufacturing tolerances and thermal movements of the sealing plate 2 can be compensated. A very simple and inexpensive construction is obtained overall.

Although the invention has been illustrated and described in detail by means of the preferred exemplary embodiment, the invention is not limited by the disclosed examples and other variants can be derived from it by a person skilled in the art without going beyond the scope of protection of the invention.

1. A wheel disk comprising:
at least one sealing plate which is fastened to the wheel disk so that it is displaceable in the circumferential direction of the wheel disk, and
at least one securing device that secures the at least one sealing plate in the properly mounted state against displacement in the circumferential direction of the wheel disk,
wherein the securing device has a screw, which is screwed to the sealing plate and extends through the sealing plater, and
an indentation, provided on the wheel disk, which receives the free end of the screw in the properly mounted state and the wall of which limits movement of the screw in the circumferential direction,
wherein the screw is screwed into a sleeve provided with an internal thread which is held non-rotatably in a through hole provided on the sealing plate.

2. The wheel disk as claimed in claim 1,
wherein the indentation is designed as a slot extending transversely to the circumferential direction.

3. The wheel disk as claimed in claim 1,
wherein the sleeve has at least one radially outward protruding projection which, during the insertion of the sleeve into the through hole, is introduced into a corresponding recess which extends from the through hole.

4. The wheel disk as claimed in claim 3,
wherein the recess of the through hole is accessible from that side of the sealing plate which faces the indentation provided on the wheel disk in the properly mounted state.

5. The wheel disk as claimed in claim 1, further comprising:
a retainer which secures the screw on the sealing plate in the properly mounted state.

6. The wheel disk as claimed in claim 5,
wherein the retainer has a securing ring which has radially outward protruding securing projections which, in the properly mounted state, engage in receiving indentations formed correspondingly on the screw and on the sealing plate such that rotation of both the screw and the securing ring is prevented.

7. The wheel disk as claimed in claim 1, wherein the screw is rounded at its free end.

8. The wheel disk as claimed in claim 1,
wherein the at least one sealing plate is held positively on the wheel disk.

9. The wheel disk as claimed in claim 7,
wherein the at least one sealing plate has an edge region which is designed in the manner of a bead and is received in a correspondingly designed undercut receiving groove of the wheel disk.
